(19) United States
(12) Patent Application Publication
(10) Pub. No.: US 2013/0138946 A1
(43) Pub. Date: May 30, 2013

(54) SECURE TELEMESSAGING

(71) Applicants: Aram Ayrapetian, Morgan Hill, CA (US); Thomas Albert Wacinski, Borex (CH)

(72) Inventors: Aram Ayrapetian, Morgan Hill, CA (US); Thomas Albert Wacinski, Borex (CH)

(73) Assignee: EasyMed Services, Inc., Vancouver (CA)

(21) Appl. No.: 13/304,352

(22) Filed: Nov. 24, 2011

(51) Int. Cl. H04L 9/00

(52) U.S. Cl. 713/150

(57) ABSTRACT

Systems and methods are described that provide for targeted distribution of messages through communication networks, such as the Internet, in private and confidential environments. Messages, such as advertisements, can be stored in a message database. In a secure environment, consumer profiles, such as medical records, can be mined to identify target consumers for a given message. Messages can be retrieved from the message database, encrypted, and conveyed to the identified target consumers without inappropriately revealing or disclosing private or confidential consumer data.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the field of telecommunications and more specifically to communications where targeted messaging and privacy of user information is important.

### BACKGROUND

In recent decades, arguably the most significant technological progress has taken place in the field of telecommunications. With the proliferation of the internet, communication networks, and mobile devices, the medium of communication has shifted to websites, email, online chat, text messaging, etc. Accordingly, the immense growth of information technology has created abundant new possibilities for conveying targeted information to individuals or entities.

In particular, the expansion of information technology has allowed distributors of information to convey target messages to specific recipients based on publicly available characteristics of the recipients. For example, advertisers can target messages to consumers based on characteristics such as sexual orientation, occupation, geographic location, interests, age, etc. However, in various contexts where it may be desirable to target messages to individuals based on particular factors, such factors can be confidential or private. For example, the medical history or personal financial information about an individual may be inaccessible to a distributor of information wishing to target individuals based on such factors because disclosure of such information would violate the individual's privacy and confidentiality. What is needed is a system and method for targeting messages to recipients based on private and confidential information about the recipients without disclosing the private information to unprivileged parties. As will be demonstrated, this invention performs this in an elegant manner.

### BRIEF DESCRIPTION OF THE DRAWINGS

FIG. 1 is a block diagram illustrating an example environment capable of implementing the systems and methods discussed herein.

FIG. 2 is a block diagram illustrating an example of message providers, a distribution module, and consumer devices.

FIG. 3 is a block diagram illustrating an example consumer device, message distribution module, external message database, and message providers, in accordance with various embodiments.

FIG. 4 illustrates a diagram of a process flow in an example message distribution module with an external message database, in accordance with various embodiments.

FIG. 5 is a block diagram illustrating an example consumer device, message distribution module, internal message database, and message providers, in accordance with various embodiments.

FIG. 6 illustrates a diagram of a process flow in an example message distribution module with an internal message database, in accordance with various embodiments.

FIG. 7 is a block diagram illustrating various components of a message distribution module 110, which includes a communication module, a processor, and a memory.

FIG. 8 is a block diagram illustrating an example computing device.

### DETAILED DESCRIPTION

In the following description, numerous specific details are set forth in order to provide a thorough understanding of the present invention. However, it will be apparent to one skilled in the art that the present invention can be practiced without these specific details. In other instances, well known circuits, components, systems, software, algorithms, and processes have not been shown in detail or have been illustrated in schematic or block diagram form in order not to obscure the present invention in unnecessary detail. Additionally, for the most part, details concerning telecommunication and telecommunication systems, encryption systems, networks, networking and computing systems, interfaces and the like have been omitted inasmuch as such details are not considered necessary to obtain a complete understanding of the present invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the Claims, the terms “including” and “comprising” are used in an open-ended fashion, and thus should be interpreted to mean “including, but not limited to . . . ”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming but would nevertheless be a routine undertaking of engineering for those of ordinary skill in the art having the benefit of this disclosure.

The systems and methods described herein provide for targeted distribution of information through communication networks, such as the Internet, in private and confidential environments. Namely, in certain situations, a distributor of information, such as a company or organization, wishing to disseminate information such as advertisements, advice, recommendations, articles, or notices may wish to target the information to specific consumers based on targeting criteria that pertains to private or confidential data about the consumers. Such targeting criteria can be based on private or confidential data such as health information, financial information, legal information, or otherwise proprietary or confidential information about consumers. For example, a company may wish to distribute advertisements to consumers afflicted with a certain disease. In such situations, the company or organization might not have access to necessary data regarding consumers to target its messages because the data may be private or confidential and not accessible by anyone outside a secure environment, such as a hospital where patient medical records are held. For example, a pharmaceutical development company may wish to disseminate information about a new drug to HIV patients. However, because medical records of individuals are confidential, the company might not have access to the information necessary to identify HIV patients in order to target its messages. Accordingly, in various embodiments, the systems and methods described herein provide for targeted distribution of messages based on targeting criteria that pertains to such confidential or private data in a way such that the confidential and private information remains protected and undisclosed.

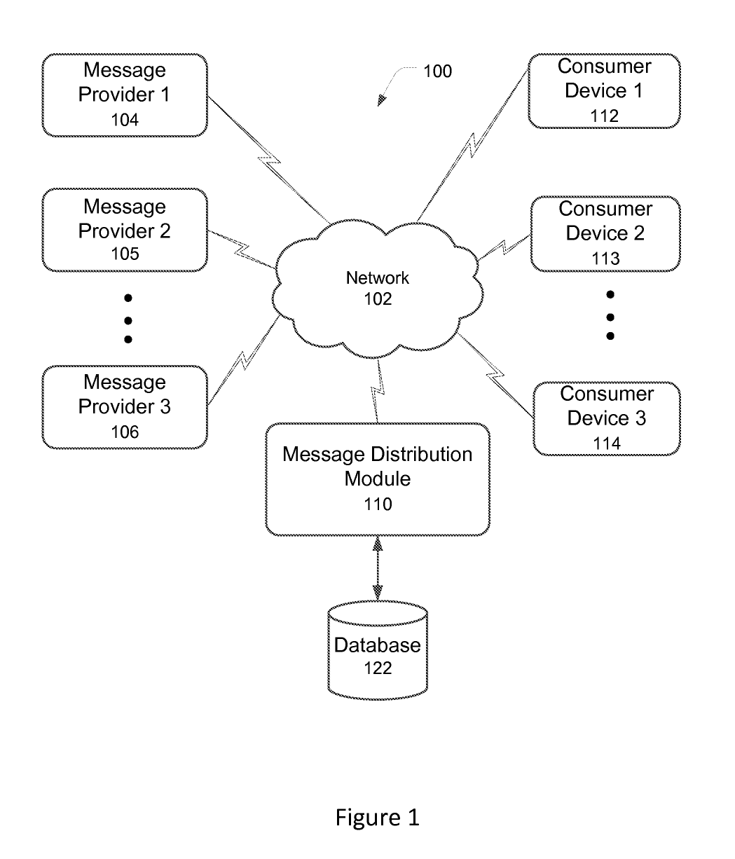

FIG. 1 is a block diagram illustrating an example environment 100 capable of implementing the systems and methods discussed herein. A data communication network 102, such as the Internet, communicates data among a variety of devices, including client servers, user devices, databases, and so forth. Data communication network 102 may be a combination of two or more networks communicating data using various communication protocols and any communication medium. The embodiment of FIG. 1 includes message providers 104, 105, 106, which can be one or more devices such as computers, web servers, or any other devices that can transmit content through a network, that transmit messages and information across the network 102. The message provider 104, 105, 106, can be located in an organization or entity seeking to distribute messages to targeted consumers. For example, message providers 104, 105, 106 can be companies or organizations providing messages such as advertisements, recommendations, and other information. Environment 100 can also include message distribution module 110, which can represent one or more web servers or similar devices that receive, manage and distribute content across a network 102. The message distribution module 110 can receive messages from message providers, such as message providers 104, 105, 106; determine which consumers should be targeted with the messages; and convey the messages to consumer devices, such as consumer devices 112, 113, 114. In various embodiments, consumer devices 112, 113, 114 can be any device capable of receiving information and displaying it on a visual and/or audio interface, such as mobile devices, smartphones, laptops, computers, tablets, and others.

A database 122 can be coupled to communicate with distribution module 110, as shown in FIG. 1. Database 122 can store various information such as messages and targeting criteria received from message providers 104, 105, 106 as well as data about consumers.

Although environment 100 illustrates three message providers 104, 105, 106; one distribution module, 110; and three consumer devices 112, 113, 114, particular environments may include any number of consumer devices, message providers, distribution modules, and other devices.

Various APIs (application programming interfaces) can be used to communicate data between the components and systems shown in FIG. 1. For example, APIs can exist between message distribution module 110 and message providers 104, 105, 106. Other APIs can exist between distribution module 110 and consumer devices 112, 113, 114. In particular embodiments, these APIs are HTTP (Hypertext Transfer Protocol) Request/Response systems. In specific implementations, message distribution module 110 can communicate with consumer devices 112, 113, 114 using JavaScript (with HTTP requests/responses) via AJAX (asynchronous JavaScript and XML) within a browser.

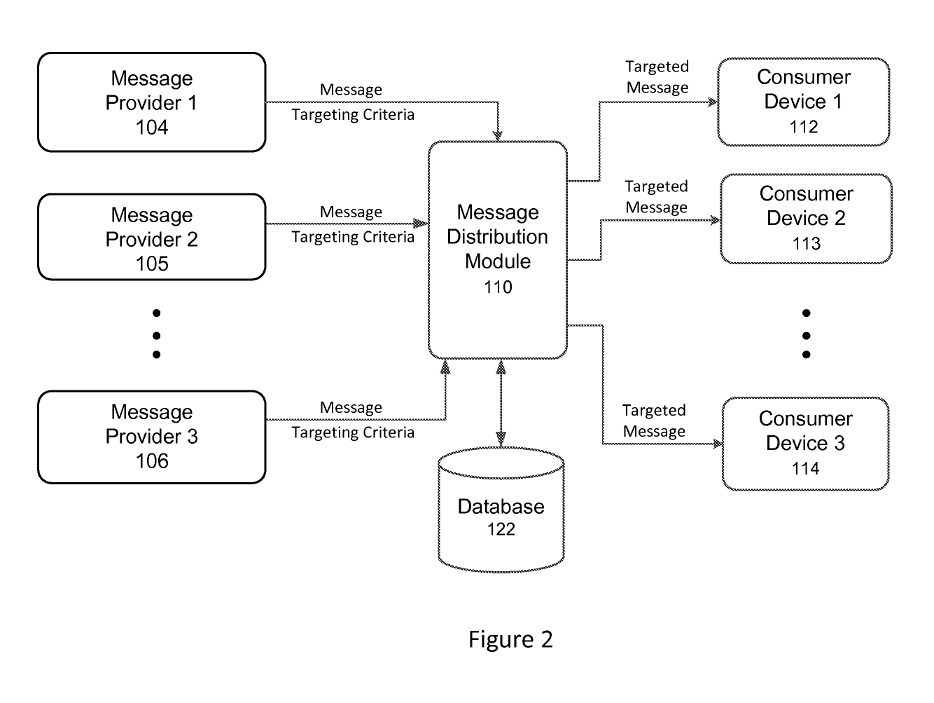

FIG. 2 is a block diagram illustrating an example of message providers, a distribution module, and consumer devices. Message providers 104, 105, 106 can convey a message, such as an advertisement for a new HIV drug, with corresponding targeting criteria, to the message distribution module 110. For example, such targeting criteria can include all HIV patients or all HIV patients in a certain stage of the disease. Based on the targeting criteria, the message distribution module 110 can identify appropriate consumers by searching through a database 122 of consumer profiles; for example, to identify all HIV patients, and convey the corresponding message to the identified consumer devices 112, 113, 114. In various embodiments, the messages sent to consumer devices 112, 113, 114 can be encrypted to further protect the consumer's privacy and confidentiality, as will be described in further detail below. In various embodiments, the message distribution module 110 can be located in a secure information environment such as a hospital, insurance company, financial institution, government organization, a data storage facility, or other entity that holds consumers information, which consumer information may be private, confidential, or proprietary and where access to the consumer information is limited to verified or privileged individuals or entities.

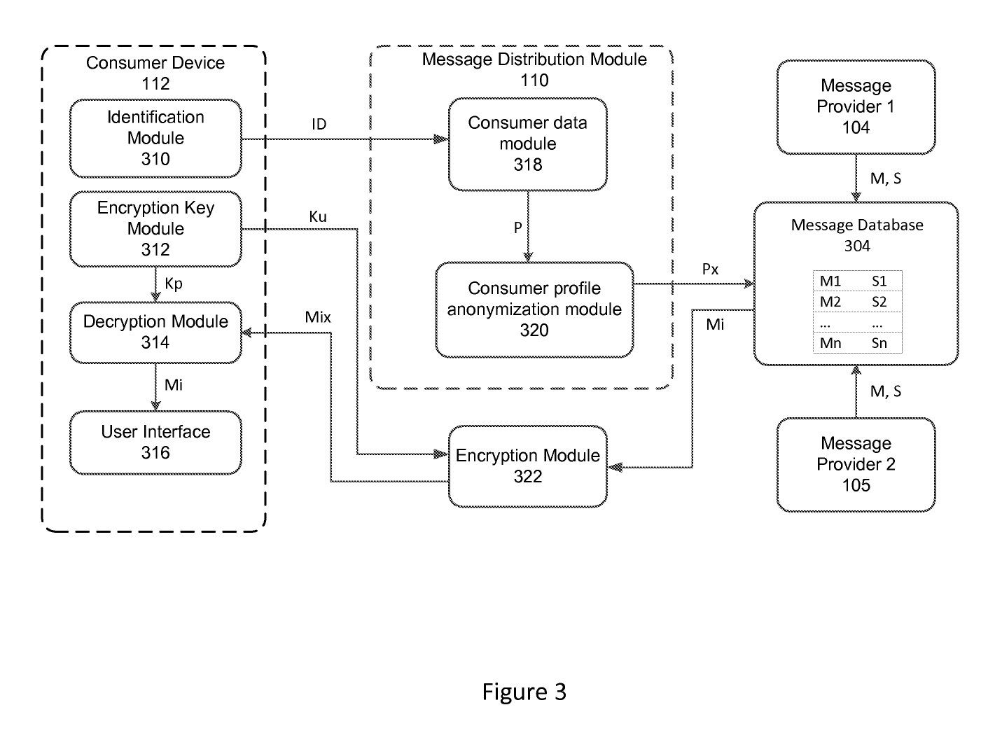

FIG. 3 is a block diagram illustrating an example consumer device 112, message distribution module 110, external message database 304, and message providers 104, 105 in accordance with various embodiments. As illustrated in the example of FIG. 3, an identification module 310 in the consumer device 112 can convey identification information “ID” to the consumer data module 318 of the message distribution module 110. The identification information can comprise any information that can be used to identify the consumer and/or the consumer device 112. For example, the identifying information can be a unique set of characters pertaining to the consumer. In various embodiments, a user may be prompted by an application to enter a username and a password into her consumer device 112 and the username and password can be conveyed to the consumer data module 318, where the consumer's identity can be recognized based on the username and password. In an embodiment, the consumer can access a website or an application through her consumer device 112 where the consumer will be prompted to enter a username and password, which username and password can be conveyed to the message distribution module 110 where the username and password can be used to verify the identity of the consumer and/or the consumer device.

In other embodiments, biometric information, such as fingerprint images, information about devices such as IP addresses, or other consumer information and/or consumer device information may be conveyed from the identification module 310 to enable identification of the consumer device 112 and/or the consumer's identity by the message distribution module 110. As will be apparent to one reasonably skilled in the art, various systems and methods are available for remote identification of consumer identity and device identity using login procedures and other unique identifiers and will not be covered here in detail for such detail is not necessary to obtain a thorough understanding of the present invention.

In various embodiments, the systems and methods of the present invention can be integrated with another internet-based application that requires secure login such as an application where a consumer can check his or her bank statements online, check his or her medical record and interact with a health-care provider online, or any other such online application. In such embodiments, once the user logs into the application, the user's identity can be verified and the consumer profile can be retrieved.

Based on the identifying information, the consumer data module 318 can identify the consumer and retrieve a consumer profile “P.” For example, a database (not illustrated) in the consumer data module 318 can contain profile information of a population of consumers. Such profile information can be a health record, such as an Electronic Health Record (EHR), which contains a consumer's medical history and health data such as age, sex, current diseases, past diseases, currently taken medications, previously taken medications, family diseases, vaccinations, location, weight, height, and medically relevant social habits. For example, the consumer data module 318 can retrieve a particular consumer's health record based on the received identifying information. In other embodiments, profile information can comprise any other type of data pertaining to the consumer, for example, financial information, legal information, or other types of information.

In various embodiments, the message distribution module 110 can be located within a secure environment where protected confidential information is held, such as a data facility holding patient health records for a hospital, a financial institution holding private financial information about clients, or any other entity holding information about a population of consumers.

The retrieved consumer profile “P” can be conveyed to a consumer profile anonymization module 320, where all personal information that can be used to identify the consumer can be removed from the consumer profile, such as the consumer's name, address, telephone number, e-mail, or any other information that can be used to reveal the consumer's identity. Namely, in this embodiment, the consumer profile can be conveyed to an external message database 304 where other parties may be able to have access to the consumer profile. In order to protect the consumer's privacy and confidentiality, all information that can be used to associate the consumer profile with the actual consumer can be removed from the consumer profile.

The anonymized consumer profile “Px” can be conveyed to a message database 304, where one or more messages can be selected based on the anonymized consumer profile. In various embodiments, the message database 304 can contain one or more messages with corresponding targeting criteria for each message.

As described above, in this embodiment, the message database 304 may be located outside of the secure environment where consumer profiles are stored. Accordingly, other parties may be able to have access to the message database 304 and to the consumer profiles conveyed to the message database 304. In order to protect the consumer's privacy and confidentiality, all information that can be used to associate the consumer profile with the actual consumer can be removed from the consumer profile before conveying to the message database 304 so that only the anonymized consumer profile “Px” is conveyed outside of the secure environment.

As illustrated in the example of FIG. 3, the message database 304 can contain a first message “M1” with corresponding targeting criteria “S1”, a second message “M2” with corresponding targeting criteria “S2,” through the nth message “Mn” with corresponding targeting criteria “Sn.” The targeting criteria for a message can comprise one or more factors based on which factors the target consumers of the message can be selected. For example, for a message “M” that is an advertisement of an HIV treatment, the targeting criteria “S” can include any patient with HIV. Similarly, for a message “M1” that is an advertisement of a diabetes treatment for children, the targeting criteria “S1” can include any patient with diabetes who is below a certain age. Hence, in the message database 304, one or more messages can be selected for the anonymized consumer profile “Px” based on the targeting criteria for the corresponding messages. In various embodiments, the messages M1 through Mn can be supplied to the message database 304 without specific targeting criteria and other methods can be used target such messages to consumers, such as key word searches, manual (human) specification of target criteria, or other methods known in the art. As will be apparent to one skilled in the art, various systems and methods exists for targeting messages to consumers based on certain characteristics of the consumer; such systems and methods will not be covered here in detail as such detail is not necessary for a thorough understanding of the invention.

In various embodiments, message providers 104, 105 can convey messages to the message database 304. The message providers 104, 105 can be any organization or entity that disseminates messages to consumers. For example, message providers 104, 105 can be drug or medical supply manufacturers, insurance companies, or healthcare organizations that wish to advertise products or services to certain consumers or government bodies or organization wishing to communicate information to certain consumers.

A selected message “Mi” based on the anonymized consumer profile “Px” can be conveyed to an encryption module 322 where the message “Mi” can be encrypted using a public encryption key “Ku” obtained from the consumer. An encryption key module 312 can advertise the consumer's public key “Ku” and/or convey the public key to the encryption module 322. The encrypted selected message “Mix” can be conveyed to the consumer device 112 and to the decryption module 314. The encryption key module 312 can convey a private key “Kp” to the decryption module 314. In the decryption module 314, the encrypted selected message “Mix” can be decrypted based on the private key “Kp” to recover the original message “Mi.” The original message “Mi” can be conveyed to a user interface 316 to be communicated to the user. For example, the message can appear as visual text or graphics on a screen of the consumer device 112 and/or as an audio communication through a speaker of the consumer device 112.

In various embodiments, different types of encryption can be used in order to protect the consumer's information from access by unverified parties. For example, various government regulations, such as HIPAA, mandate that messages pertaining to a person's medical information are conveyed securely. As will be apparent to one reasonably skilled in the art, various systems and methods are available for performing encryption, such as public key encryption, and will not be covered here in detail for such detail is not necessary to obtain a thorough understanding of the present invention.

Although FIG. 3 illustrates one consumer device 112, one message distribution module 110, and two message providers 104, 105, as will be apparent to one skilled in the art, in various embodiments the system can contain more than one consumer device, more than one message distribution module, and more than two message providers.

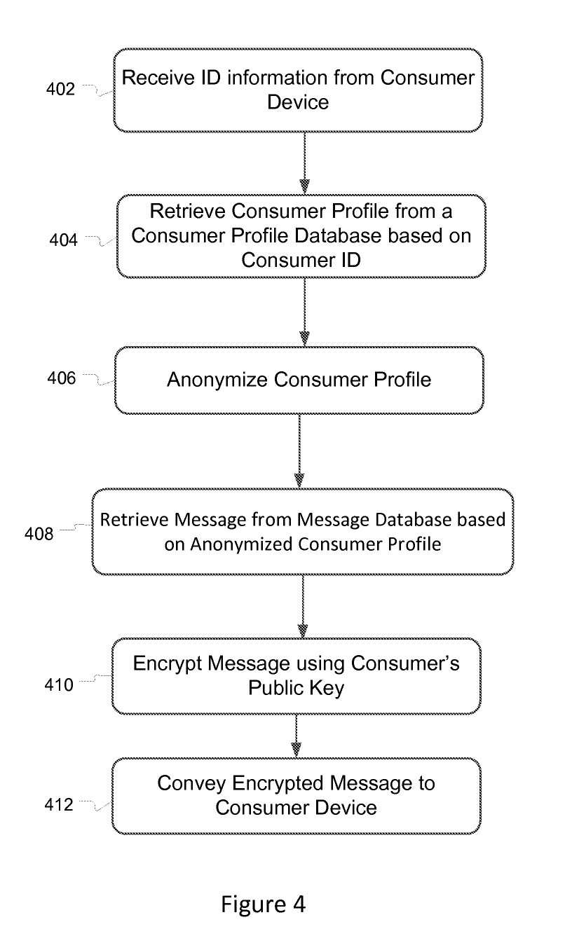

FIG. 4 illustrates a diagram of a process flow in an example message distribution module with an external message database, in accordance with various embodiments. The process flow illustrated in FIG. 4 can correspond to processes in a system such as the system illustrated in FIG. 3. As illustrated in the figure, the message distribution module can receive ID information from a consumer device. As described above, the ID information can contain any data that can be used to uniquely identify the consumer. After the consumer is identified based on the received ID information, the consumer's profile, which can contain any information corresponding to the consumer, can be retrieved from a consumer profile database 404. For example, the consumer profile can be an individual's health record and the consumer profile database can be a database, located within a hospital or a data storage facility employed by the hospital, containing the health records of a population of consumers. In various embodiments, the consumer profile can contain any information corresponding to the consumer, such as financial information, legal information, or other types of information.

After the consumer profile is retrieved, the consumer profile can be anonymized 406 to remove all information that can be used to identify the consumer from the consumer profile, such as the consumer's name, address, telephone number, e-mail, or any other information that can be used to reveal the consumer's identity. Namely, because in this embodiment the consumer profile will be conveyed to an external message database where other parties may be able to access the consumer profiles that are conveyed to the message database, in order to protect the consumer's privacy and confidentiality, all information that can be used to associate the consumer profile with the actual consumer can be removed from the consumer profile before conveying to the message database.

A message can be retrieved from the message database based on the anonymized consumer profile 408. In various embodiments, the message database can contain one or more messages with corresponding targeting criteria for each message. For example, a message may be an advertisement supplied from a drug manufacture and the targeting criteria corresponding to the message can describe the types of consumers to whom the advertisement should be targeted. Alternatively, the message can be a health recommendation from a government or healthcare organization and the targeting criteria corresponding to the message can describe the types of consumers to whom the recommendation should be targeted. For example, such a recommendation can be specific dietary advice for diabetics and the targeting criteria can include all adult diabetic patients.

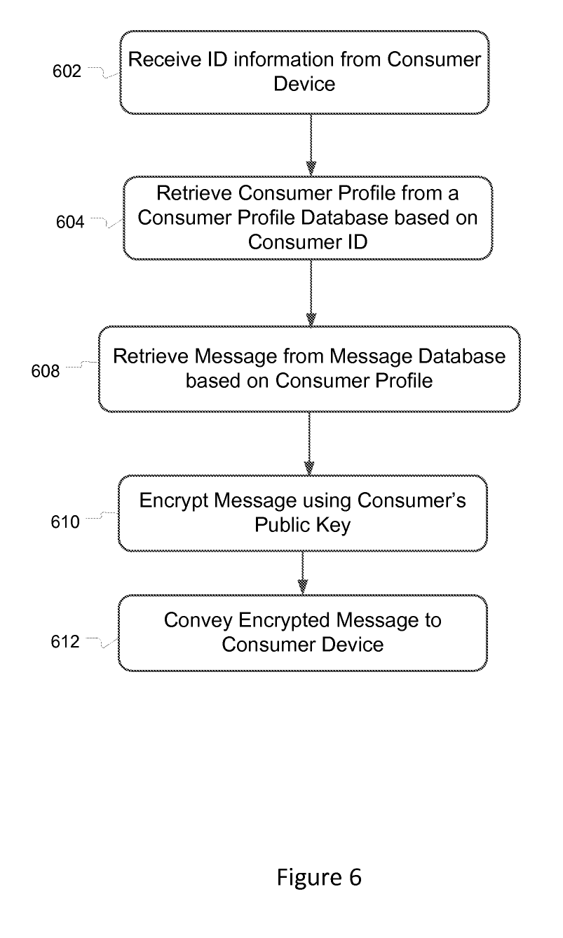

Once a message for the consumer is retrieved, the message can be encrypted using a consumer's public encryption key 410. The public encryption key, as would be understood by a person reasonably skilled in the art, can be publicly advertised by the consumer device. Encryption can be used in order to protect the consumer's information from access by unverified parties. For example, various government regulations mandate that messages pertaining to a person's medical information are conveyed securely. The encrypted message can then be conveyed to the consumer device 412. In the consumer device, the message can be decrypted using the consumer's private encryption key (step not illustrated in FIG. 6). The message can then be communicated to the consumer through a visual or audio interface.

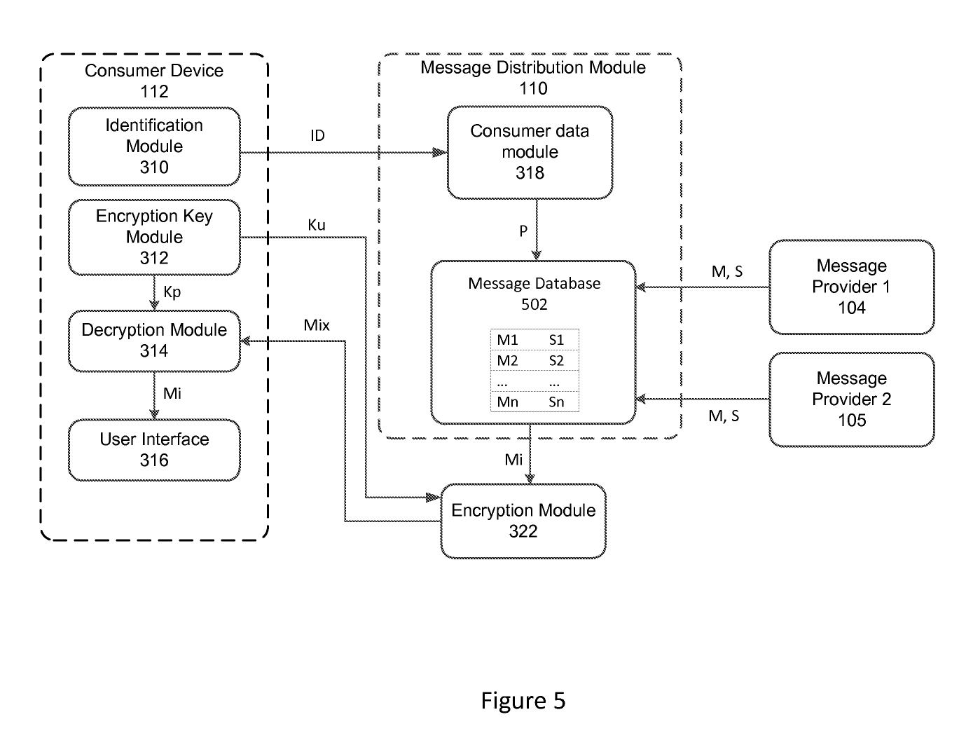

FIG. 5 is a block diagram illustrating an example consumer device 112, message distribution module 110, internal message database 502, and message providers 104, 105 in accordance with various embodiments. As illustrated in the example of FIG. 5, an identification module 310 in the consumer device 112 can convey identification information “ID” to the consumer data module 318 of the message distribution module 110 to identify the consumer, as described above. Based on the identifying information, the consumer data module 318 can identify the consumer and retrieve a consumer profile “P” from a consumer profile database. The retrieved consumer profile “P” can be conveyed to a message database 502, where one or more messages can be selected based on the consumer profile. In various embodiments, the message database 502 can contain one or more messages with corresponding targeting criteria for each message.

In this embodiment, unlike the example of FIG. 3, the message database 502 may be located inside the secure environment where consumer profiles are stored. Accordingly, unverified parties may not have access to the message database 502 and to the consumer profiles conveyed to the message database 502. Thus, in this embodiment, anonymization of consumer profiles may not be necessary to protect consumer information.

As illustrated in the example of FIG. 5, the message database 502 can contain a first message “M1” with corresponding targeting criteria “S1”, a second message “M2” with corresponding targeting criteria “S2,” through the nth message “Mn” with corresponding targeting criteria “Sn.” The targeting criteria for a message can comprise one or more factors based on which target consumers of the message will be selected. For example, for a message “M” that is an advertisement of an HIV treatment, the targeting criteria “S” can include any patient with HIV. Similarly, for a message “M” that is an advertisement of a diabetes treatment for children, the targeting criteria “S” can include any patient with diabetes who is below a certain age. Hence, in the message database 502, one or more messages can be selected for the consumer profile “P” based on the targeting criteria for the corresponding messages. In various embodiments, the messages M1 through Mn can be supplied to the message database 502 without specific targeting criteria and other methods can be used target such messages to consumers, such as key word searches, manual (human) specification of target criteria, or other methods known in the art. As will be apparent to one skilled in the art, various systems and methods exists for targeting messages to consumers based on certain characteristics of the consumer; such systems and methods will not be covered here in detail as such detail is not necessary for a thorough understanding of the invention.

In various embodiments, message providers 104, 105 can convey messages to the message database 502. The message providers 104, 105 can be any organization or entity that disseminates messages to consumers. For example, message providers 104, 105 can be drug or medical supply manufacturers or healthcare organizations that wish to advertise products or services to certain consumers or government bodies or organization wishing to communicate information to certain consumers.

A selected message “Mi” based on the anonymized consumer profile “Px” can be conveyed to an encryption module 322, where the message “Mi” can be encrypted using a public encryption key “Ku” obtained from the consumer. An encryption key module 312 can advertise the consumer's public key “Ku” and convey the public key to the encryption module 322. The encrypted selected message “Mix” can be conveyed to the consumer device 112 and to the decryption module 314. The encryption key module 312 can convey a private key “Kp” to the decryption module 314. In the decryption module 314, the encrypted selected message “Mix” can be decrypted based on the private key “Kp” to recover the original message “Mi.” The original message “Mi” can be conveyed to a user interface 316 to be communicated to the user. For example, the message can appear as visual text or graphics on a screen of the consumer device 112 and/or as an audio communication through a speaker of the consumer device 112.

In various embodiments, different types of encryption can be used in order to protect the consumer's information from access by unverified parties. For example, various government regulations mandate that messages pertaining to a person's medical information are conveyed securely. As will be apparent to one reasonably skilled in the art, various systems and methods are available for performing encryption, such as public key encryption, and will not be covered here in detail for such detail is not necessary to obtain a thorough understanding of the present invention.

Although FIG. 5 illustrates one consumer device 112, one message distribution module 110, and two message providers 104, 105, as will be apparent to one skilled in the art, in various embodiments the system can contain more than one consumer device, more than one message distribution module, and more than two message providers.

FIG. 6 illustrates a diagram of a process flow in an example message distribution module with an internal message database, in accordance with various embodiments. The process flow illustrated in FIG. 6 can correspond to processes in a system such as the system illustrated in FIG. 5. As illustrated in the figure, the message distribution module can receive ID information from a consumer device. As described above, the ID information can contain any data that can be used to uniquely identify the consumer. After the consumer is identified based on the received ID information, the consumer's profile, which can contain any information corresponding to the consumer, can be retrieved from a consumer profile database 604. For example, the consumer profile can be an individual's health record and the consumer profile database can be a database, located within a hospital, containing the health records of a population of consumers. In various embodiments, the consumer profile can contain any information corresponding to the consumer, such as financial information, legal information, or other types of information.

A message can be retrieved from the message database based on the consumer profile 608. In various embodiments, the message database can contain one or more messages with corresponding targeting criteria for each message. For example, a message may be an advertisement supplied from a drug manufacture and the targeting criteria corresponding to the message can describe the types of consumers to whom the advertisement should be targeted. Alternatively, the message can be a health recommendation from a government or healthcare organization and the targeting criteria corresponding to the message can describe the types of consumers to whom the recommendation should be targeted. For example, such a recommendation can be specific dietary advice for diabetics and the targeting criteria can include all adult diabetic patients.

Once a message for the consumer is retrieved, the message can be encrypted using the consumer's retrieved public encryption key 610. The public encryption key, as would be understood by a person reasonably skilled in the art, can be publicly advertised by the consumer device. Encryption can be used in order to protect the consumer's information from access by unverified parties. For example, various government regulations, such as HIPAA, mandate that messages pertaining to a person's medical information are conveyed securely. The encrypted message can then be conveyed to the consumer device 612. In the consumer device, the message can be decrypted using the consumer's private encryption key (step not illustrated in FIG. 6). Once decrypted, the message can be communicated to the consumer through a visual or audio interface

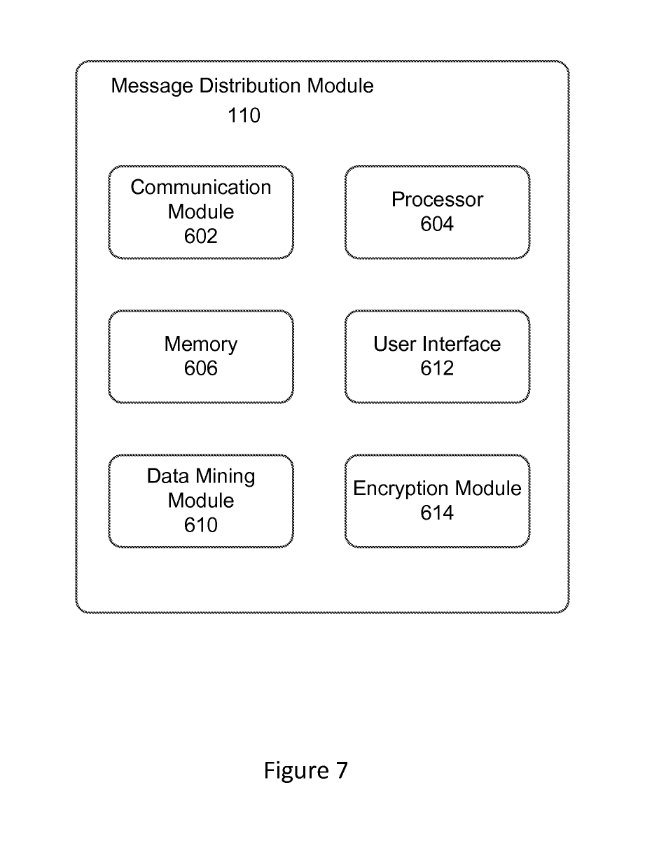

FIG. 7 is a block diagram illustrating various components of a message distribution module 110, which includes a communication module 602, a processor 604, and a memory 606. Communication module 602 allows message distribution module 110 to communicate with other devices and systems, such as message providers 104, 105, 106 and consumer devices 112, 113, 114 shown in FIG. 1. Processor 604 executes various instructions to implement the functionality provided by the message distribution module 110. Memory 606 stores these instructions as well as other data used by processor 604 and other modules contained in message distribution module 110.

The behavior analysis module 110 also includes an encryption module 614, which encrypts information, such as messages, that is conveyed to other devices such as the consumer devices 112, 113, 114 shown in FIG. 1. The behavior analysis module 110 also includes a data mining module 310, which searches for data through knowledge bases, such as consumer profile databases, the message database 304 in FIG. 3, and/or the message database 502 in FIG. 5 and retrieves data, such as consumer profiles and messages. A user interface 612 allows administrators, web developers, and other users to interact with the various components of the behavior analysis module 110.

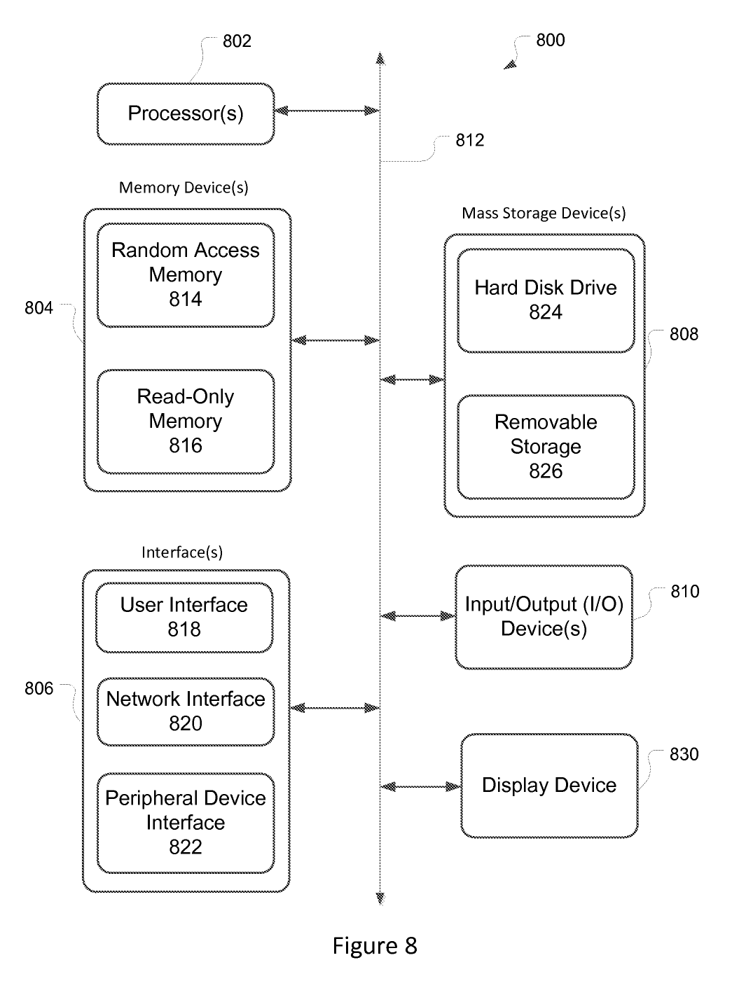

FIG. 8 is a block diagram illustrating an example computing device 800. Computing device 800 may be used to perform various procedures, such as those discussed herein. Computing device 800 can function as a server, a client, a user device, message distribution module, or any other computing entity. Computing device 800 can be any of a wide variety of computing devices, such as a desktop computer, a notebook computer, a server computer, a handheld computer, a smart phone, a tablet, and the like.

Computing device 800 includes one or more processor(s) 802, one or more memory device(s) 804, one or more interface(s) 806, one or more mass storage device(s) 808, one or more Input/Output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM)) 814 and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid state memory (e.g., Flash memory), and so forth. One type of mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, lenses, CCDs or other image capture devices, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 include any number of different network interfaces 820, such as interfaces to local area networks (LANs), wide area networks (WANs), wireless networks, and the Internet. Other interfaces include user interface 818 and peripheral device interface 822.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the system and method described herein facilitate conveying targeted messages based on private or confidential recipient information. Although the components and modules illustrated herein are shown and described in a particular arrangement, the arrangement of components and modules may be altered to perform analysis and configure content in a different manner. In other embodiments, one or more additional components or modules may be added to the described systems, and one or more components or modules may be removed from the described systems. Alternate embodiments may combine two or more of the described components or modules into a single component or module.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” “various embodiments” or “other embodiments” means that a particular feature, structure, or characteristic described in connection with the embodiments is included in at least some embodiments, but not necessarily all embodiments. References to “an embodiment,” “one embodiment,” or “some embodiments” are not necessarily all referring to the same embodiments. If the specification states a component, feature, structure, or characteristic “may,” “can,” “might,” or “could” be included, that particular component, feature, structure, or characteristic is not required to be included. If the specification or Claims refer to “a” or “an” element, that does not mean there is only one of the element. If the specification or Claims refer to an “additional” element, that does not preclude there being more than one of the additional element.

1. A method, comprising:
receiving identifying information from a consumer device;
retrieving a consumer profile from a consumer profile database based on the identifying information;
retrieving a message from a message database based on the retrieved consumer profile;
encrypting the retrieved message; and
conveying the encrypted message to the consumer device.

2. The method of claim 1, wherein the retrieved message is encrypted using public key encryption.

3. The method of claim 1, further comprising:
anonymizing the consumer profile retrieved from the consumer data database by removing personal information about the consumer from the consumer profile.

4. The method of claim 1, wherein the message database is a database comprising at least one of: health-related advertisements, financial advertisements, legal advertisements, health-related advice, financial advice, and legal advice.

5. The method of claim 1, wherein the consumer profile database is a database comprising at least one of: health information about consumers, financial information about consumers, and legal information about consumers.

6. The method of claim 1, wherein the consumer device comprises at least one of a smartphone, a laptop computer, a tablet, a cellular phone, and a desktop computer.

7. The method of claim 1, wherein the consumer profile retrieved from the consumer profile database comprises information about the consumer's health including at least one of age, sex, current diseases, past diseases, currently taken medications, previously taken medications, family diseases, vaccinations, location, weight, height, and medically relevant social habits.

8. The method of claim 1, wherein the consumer profile retrieved from the consumer profile database comprises an Electronic Health Record.

9. The method of claim 1, wherein the message database further comprises corresponding targeting criteria for a message, which targeting criteria describes what category of consumers said message should be conveyed to.

10. A system, comprising:
a consumer profile database;
a consumer data module configured to receive identifying information from a consumer device and to retrieve a consumer profile from the consumer profile database based on the identifying information;
a consumer profile anonymization module configured to anonymize the consumer profile retrieved from the consumer data database by removing personal information about the consumer from the consumer profile;
a message database configured to retrieve a message from the message database based on the anonymized consumer profile; and
an encryption module configured to encrypt the retrieved message.

11. The system of claim 10, wherein the encryption module is further configured to encrypt the retrieved message using public key encryption.

12. The system of claim 10, wherein the message database is a database comprising at least one of: health-related advertisements, financial advertisements, legal advertisements, health-related advice, financial advice, and legal advice.

13. The system of claim 10, wherein the consumer profile database is a database comprising at least one of: health information about consumers, financial information about consumers, and legal information about consumers.

14. The system of claim 10, wherein the consumer profile retrieved from the consumer profile database comprises information about the consumer's health including at least one of age, sex, current diseases, past diseases, currently taken medications, previously taken medications, family diseases, vaccinations, location, weight, height, and medically relevant social habits.

15. The system of claim 10, wherein the consumer profile retrieved from the consumer profile database comprises an Electronic Health Record.

16. The system of claim 10, wherein the message database further comprises corresponding targeting criteria for a message, which targeting criteria describes what category of consumers said message should be conveyed to.

17. A system, comprising:
a consumer profile database;
a consumer data module configured to receive identifying information from a consumer device and to retrieve a consumer profile from the consumer profile database based on the identifying information;
a message database configured to retrieve a message from the message database based on the consumer profile; and
an encryption module configured to encrypt the retrieved message.

18. The system of claim 17, wherein the encryption module is further configured to encrypt the retrieved message using public key encryption.

19. The system of claim 17, wherein the consumer profile retrieved from the consumer profile database comprises information about the consumer's health including at least one of age, sex, current diseases, past diseases, currently taken medications, previously taken medications, family diseases, vaccinations, location, weight, height, and medically relevant social habits.

20. The system of claim 17, wherein the message database further comprises corresponding targeting criteria for a message, which targeting criteria describes what category of consumers said message should be conveyed to.
